(19) United States
(12) Patent Application Publication
(10) Pub. No.: US 2007/0141540 A1
(43) Pub. Date: Jun. 21, 2007

(54) Recipe generating methods and systems

(75) Inventor: Scott Borg, Norwich, VT (US)

Correspondence Address: PERKINS COIE LLP/CARGILL, INC., P.O. BOX 1247, SEATTLE, WA, 98111-1247, US

(73) Assignee: Cargill, Incorporated, Wayzata, MN (US)

(21) Appl. No.: 10/558,546

(22) PCT Filed: Sep. 30, 2005
(86) PCT No.: PCT/US05/35347

§ 371 Date: Dec. 6, 2006

Related U.S. Application Data
(60) Provisional application No. 60/614,962, filed on Sep. 30, 2004.

(51) Int. Cl. G09B 19/00

(52) U.S. Cl. 434/127

(57) ABSTRACT

The methods and systems for generating recipes are disclosed. One aspect of the invention is directed toward a method for generating a recipe that includes receiving a request for a recipe recommendation, collecting customer information, and providing a recipe based on the customer information, a defined promotional strategy, or relationship between the purchase of selected food items. Further aspects of the invention can include providing a list of food items related to the recipe, generating a store map with the location of food items, providing discount incentives for food items related to the recipe, and generating a shopping sequence for collecting food items related to the recipe.

### CROSS-REFERENCE TO RELATED APPLICATION

This patent application claims priority from U.S. Provisional Patent Application No. 60/614,962, which is herein incorporated by reference.

### TECHNICAL FIELD

Embodiments of the present invention relate to methods and systems for generating recipes in a retail environment and other applications.

### BACKGROUND

Meal planning and grocery shopping can be time consuming, difficult, and frustrating for many consumers. For example, the simple process of choosing menus, making a grocery list, and shopping for the groceries can be greatly complicated when the grocery store is out of specific items needed for the planned menus. This situation can result in the consumer having to make real-time changes to his or her meal planning and/or shopping list while at a grocery store. Additionally, these changes are often made without access to a recipe book, making the process even more difficult and frustrating.

The process can be further complicated for budget-minded consumers who attempt to plan meals around sale items and various promotions, e.g., coupons. For example, a consumer may desire to save money by planning a meal around a certain sale item, but lack a recipe that uses the sale item. In other cases, consumers may be unfamiliar with certain food items or how certain food items can be incorporated into a meal, e.g., they may be unaware of certain cuts of meats. In still other situations, consumers want to try new dishes but lack the time required to cull recipes that are desirable and/or meet selected nutritional criteria. Despite the difficulties, frustrations, and inefficiencies involved, meal planning and grocery shopping remain a necessary chore for most consumers.

### BRIEF DESCRIPTION OF THE DRAWINGS

FIG. 1 is a flow chart of a computing system in accordance with an embodiment of the invention.

FIG. 2 is a flow chart of a process for providing a recipe in accordance with embodiments of the invention.

FIG. 3 is a flow chart of a process for providing a recipe in accordance with other embodiments of the invention.

FIG. 4 is a flow chart of a process for providing a recipe in accordance with still other embodiments of the invention.

FIG. 5 is a flow chart of a process for providing a recipe in accordance with still other embodiments of the invention.

FIG. 6 is a flow chart of a process for defining a promotional strategy in accordance with still other embodiments of the invention.

FIG. 7 is a block diagram showing a system for providing a recipe in accordance with still other embodiments of the invention.

### DETAILED DESCRIPTION

A. Overview

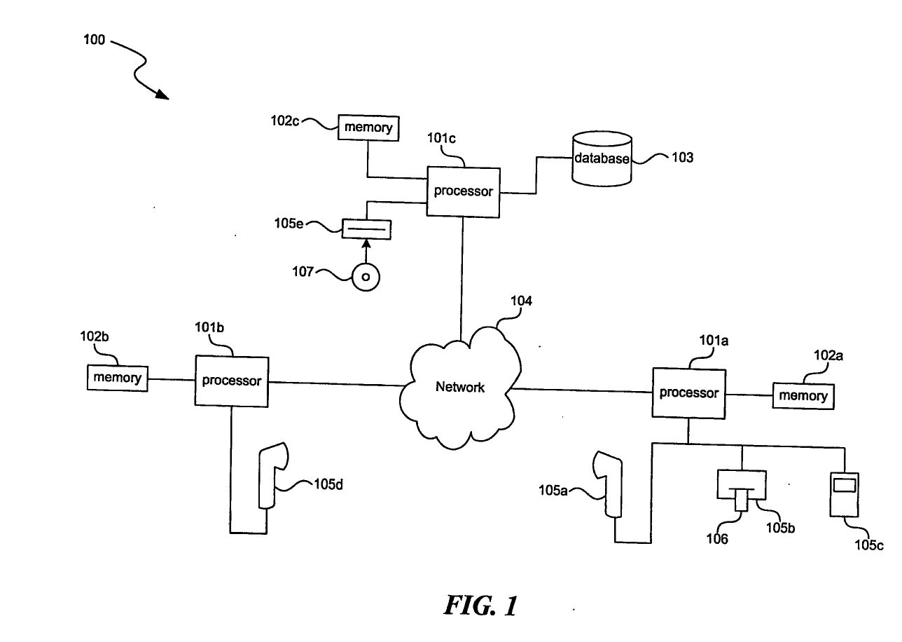

The present disclosure describes methods and systems for generating recipes. Several specific details of the invention are set forth in the following description and in FIGS. 1-7 to provide a thorough understanding of certain embodiments of the invention. One skilled in the art, however, will understand that the present invention may have additional embodiments, and that other embodiments of the invention may be practiced without several of the specific features described below.

One aspect of the invention is directed toward a process of generating a recipe that includes collecting initial customer information and generating an initial customer profile based on the initial customer information. The method can further include identifying items purchased by the customer and generating a current customer profile that incorporates data relating to the identified items and the initial customer profile. A recipe request is received and at least one recipe based on the current customer profile is provided. Further aspects of the invention can include providing a list of food items related to the recipe, generating a store map with the location of food items, providing discount incentives for food items related to the recipe, and generating a shopping sequence for collecting food items related to the recipe.

Another aspect of the invention is directed toward a method for generating a recipe that includes receiving a request for a recipe recommendation, collecting customer information, and comparing the customer information to a defined promotional strategy. The method can further include providing a recipe to the customer or another customer based on the comparison of the customer information and the defined promotional strategy. In a certain aspect of the invention, the defined promotional strategy can include at least one strategy directed toward increasing sales of a selected food item, e.g., a selected cut of meat.

Still another aspect of the invention is directed toward a method for generating a recipe that includes receiving a request for a recipe recommendation, collecting customer information, and forming relationships between food items. The relationships between food items can be based on the probability that if a customer buys a first food item, the customer will also buy a second food item. The method can further include comparing the customer information, a defined promotional strategy, and the relationship between food items. The method can still further include providing a recipe based on the comparison of the customer information, the relationship between food items, and the store promotional strategy.

B. Computing Systems

As noted above, aspects of the invention provide a description of methods and systems for generating recipes in a retail environment or other applications. Many embodiments of the invention described herein may take the form of computer-executable instructions, such as routines executed by a programmable computer or computing system (e.g., a personal computer). Those skilled in the relevant art will appreciate that the invention can be practiced on other computer system configurations as well. The invention can be embodied in a special-purpose computer or data processor, e.g., an ASIC, that is specifically configured to form one or more of the computer-executable instructions described below. Accordingly, the term “computing system” as generally used herein includes any processor (or group of processors) and can include internet appliances, handheld devices (including palm-top computers, wearable computers, and cellular or mobile phones), multi-processor systems, processor-based or programmable consumer electronics, mini-computers, touch screens, and the like.

The invention can also be practiced in distributed computing environments in which tasks or modules typically are performed by remote processing devices that are linked through a communications network (e.g., a local area network, a wide area network, or the Internet). In a distributed computing environment, program modules or subroutines may be located in both local and remote memory storage devices. Aspects of the invention described below may be stored or distributed on computer-readable media, including magnetic or optical readable computer disks (e.g., removable disks such as CD-ROM or flash drives), as well as distributed electronically over wired or wireless networks. Data structures and transmission of data particular to aspects of the invention are also encompassed within the scope of the invention.

An example of a computing system 100 is shown in FIG. 1, and includes a processor 101 (three are shown as a first processor 101a, a second processor 101b, and a third processor 101c), a database 103, and a network 104. In FIG. 1, the first processor 101a can be connected to a first memory 102a and various peripheral devices 105 including, for example, a scanning device 105a, a printer 105b, and a handheld device 105c. The printer 105b can print various items 106, e.g., recipes, lists of food items, maps, sequences, and/or coupons. The first processor 101a can be coupled to the second processor 101b and the third processor 101c via the network 104, e.g., a local area network, a wide area network, and/or the internet. The second processor 101b can be connected to a second memory 102b and to a peripheral device 105d, e.g., a scanner. The third processor 101c can be connected to a third memory 102c, a database 103, and a peripheral device 105e that includes a reader for reading a computer-readable medium 107. The processors 101a, 101b, and 101c can be communicatively coupled between each other using a peer to peer protocol or can be arranged in a client-server configuration. For example, processor 101c can be configured as a server providing information stored in the database 103 to processors 101b and 101c via the network 104. All communicative coupling can be achieved either via a hard-wire connection, a wireless connection, or a combination of both. As noted above, other arrangements can have other configurations and can have more or fewer elements; in certain embodiments, a single processor without a network connection can be used and/or various combinations of peripheral devices 105 can be connected to various processors 101.

C. Recipes Based on Customer Profiles and Promotional Strategy

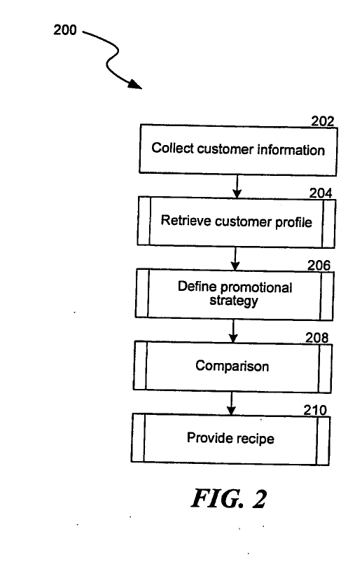

FIG. 2 illustrates a process 200 of generating a recipe based on a customer profile and a promotional strategy that is targeted toward customer needs and preferences. The process 200 can further consider current supply chain conditions in generating the recipes. Process portion 202 of the process 200 includes collecting customer information that can be used to identify a customer with a particular customer profile. The customer information can include a customer identifier. For example, a customer identifier can be assigned to one or more items of the information, e.g., customer name, customer phone number, and/or a store affinity card number, and customer credit card.

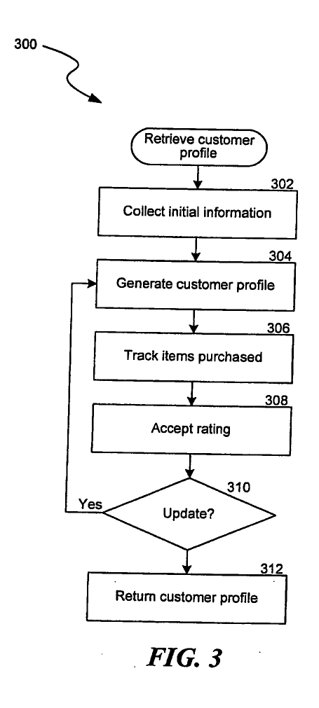

As shown in process portion 204, the customer information can be used to obtain a customer profile including data relating to predictions of certain customer preferences regarding food and shopping that were not explicitly stated by the customer. For example, the customer profile may allow categorization of the customer into various categories or customer types that share common characteristics (e.g., families with children vs. singles, price conscientious vs. brand conscientious). Although the consumer may not have thought about certain recipes and/or even be familiar with certain food items, recipes that the customer is likely to enjoy can be recommended based on these common characteristics and/or other customer information. Various embodiments of obtaining the customer profile are further described below with reference to FIG. 3.

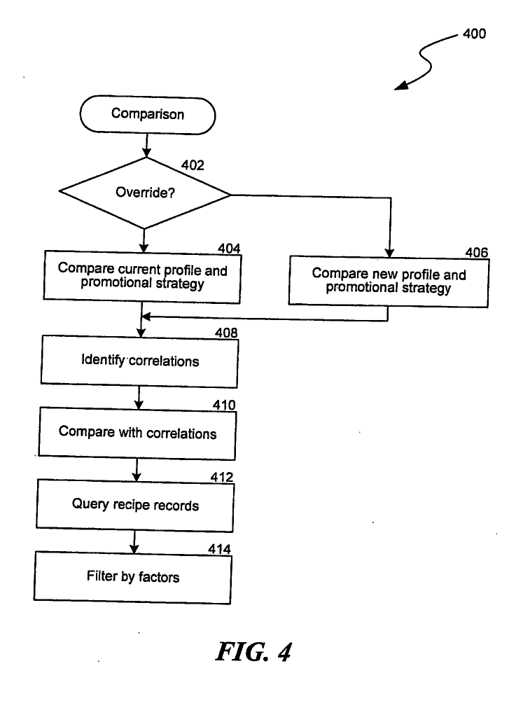

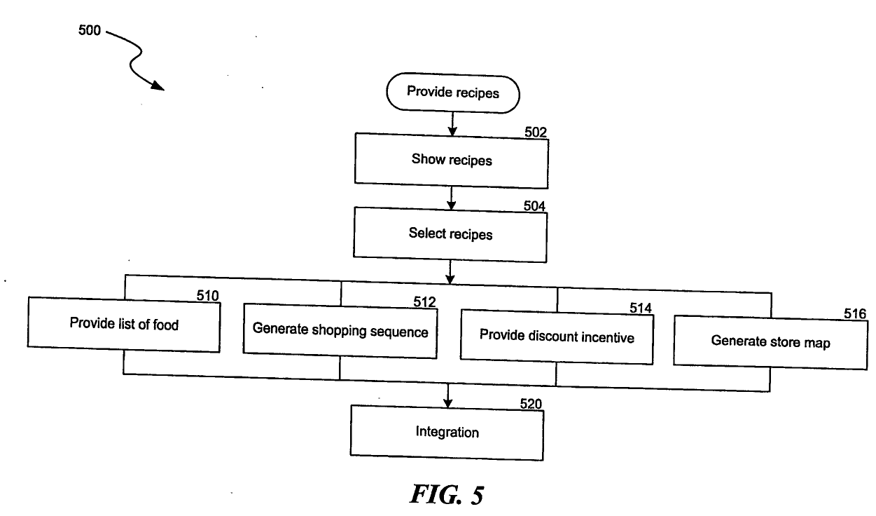

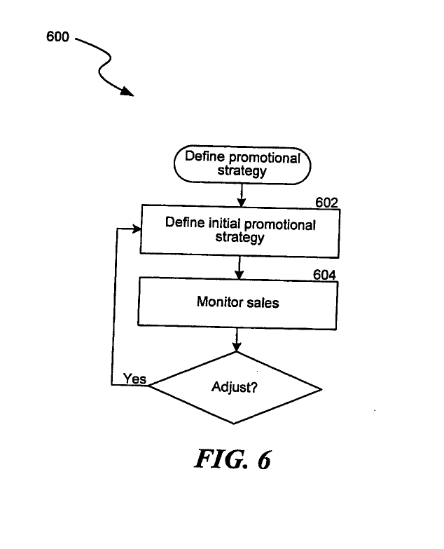

The process 200 can further include defining a promotional strategy (process portion 206), comparing the obtained user profile with a promotional strategy (process portion 208), and providing a recipe based on the comparison (process portion 210). The process of defining a promotional strategy is further described below with reference to FIG. 6. In some embodiments, the comparing process portion 208 can include taking various other factors into consideration as further described below with respect to FIG. 4. In some embodiments, multiple recipes can be provided and one or more of the multiple recipes can be selected as further described below with reference to FIG. 5. In certain embodiments, the customer can make a recipe request and/or be provided a recipe via an in-store kiosk or an at-home computer. In other embodiments, the customer can interface with a concierge or other store representative who generates or processes the request and provides the customer with a recipe identified by the computer system 100.

In still other embodiments, only recipes containing food items that are currently stocked by the store are provided. In some embodiments, recipes that include food items that are discounted (e.g., on sale or subject to a redeemable coupon) are given priority over recipes containing only non-discounted items (e.g., priority recipes can be listed ahead of other recipes or provided in lieu of other recipes). In certain other embodiments, the current customer profile can also include a history of recipes that have been provided to the customer and the recipes can be prioritized so that the customer does not receive the same recipe multiple times without intervening suggestions. Alternatively, priority can be accorded to a customer's favorite recipes, e.g., recipes that are chosen multiple times by a customer and/or recipes that the customer identifies as being well liked.

For example, in one embodiment, the customer can go to a meat counter and ask a butcher for purchase advice, such as which cuts of meat are available or what cuts are on sale. The butcher can access a computing system, e.g., the system 100 of FIG. 1, enter a customer identifier (e.g., swipe the customer's affinity card or enter the customer's name or phone number) and request a recipe. The butcher can then receive one or more recipes based on the customer profile and the promotional strategy, discuss the recipe options with the customer to select one or more of the recipes, and provide the selected recipe(s) to the customer. Each recipe can include a recipe for a single dish and/or a recipe for an entire meal or even a dinner party. For example, in some embodiments, a recipe can include multiple appetizers, salads, soups, multiple main courses, multiple side dishes, multiple desserts, and multiple beverages and include the ingredients and preparation process for each.

As discussed above, any or all of the method steps or process portions described herein can be accomplished wholly or in part using one or more computing device and/or executable instructions contained on a computer-readable medium. For example, referring back to FIG. 1, the first processor 101a can include an in-store kiosk or an in-home personal computer. The second processor 191b can be coupled to a self-serve checkout station or an employee-operated register, and the third processor can include a store computer and/or server connected to the database 103.

A feature of at least some of the embodiments described above is that recipes consistent with customer preferences and/or projected customer preferences can be provided real-time in a retail environment. An advantage of this feature is that customers can be exposed to new recipes and/or new food items that they are likely to enjoy based on their profiles. Another feature of embodiments described above is that the recipes include items that are in stock, on sale, or provide good value even if not on sale. Prior to providing a recipe to a customer, any recipe that calls for out-of-stock items can be omitted. An advantage of this feature is that the frustration of planning a meal and finding out that one or more required food items is not in stock can be avoided. An additional advantage of this feature is that consumers can be provided recipes that are associated with discounts providing an overall cost savings.

Another feature of embodiments described above is that recipes can be generated that are consistent with customer information, promotional strategies, and/or other relationships. This can result in the increased sale of selected products, ancillary products, and/or total products at a given location. Additionally, the percentage of a customer's food budget spent in a specific store can also be increased. An advantage of this feature is that the increases in sales can increase the overall store revenues.

D. Obtaining Customer Profile

FIG. 3 illustrates a process 300 of obtaining a customer profile based on collected customer information. As shown in process portion 302, if a customer does not have an existing customer profile, a customer profile can be generated by collecting initial customer information. For example, a customer can fill out a written survey, be asked questions by a store representative (e.g., a concierge, store employee, and/or contractor), or input information into a computer (e.g., a kiosk in the store and/or a home computer connected to a store computer via the internet). The initial customer information can include food preferences, cooking preferences, and other food and shopping related information. For example, the information can include the number of people in the customer's family, dietary restrictions such as food allergies and/or religious food restrictions, the time dedicated to meal preparation, and other preferences (e.g., a preference for a low carbohydrate diet, a vegetarian diet, and/or a low-fat diet).

As shown in process portion 304, based on the collected initial customer information, a customer profile can be generated for the customer. The customer profile can include all initial customer information collected as well as information derived based on common statistics. For example, if a customer has a large number of family members, the customer is likely to be more price conscientious than brand conscientious. Optionally, the initial customer profile can combine with other information and/or is analyzed to create a customer profile that provides food and shopping information related to the customer. For example, demographic information (e.g., preferences that are generally seen in a certain area of the country, in certain age groups, or by certain ethnic groups) can be combined with the customer information to generate a profile.

In a further embodiment, the customer profile can also be generated based on initial profiling by a store representative in addition to the initial customer information collected. For example, a store representative can observe items the customer already intends to purchase, answer questions asked by the customer, such as location of on-sale items or a specific brand of items, and examine behavioral characters of the customer, i.e., whether the customer is a rational shopper or a compulsive shopper. The initial profiling is then used in further defining the customer profile.

The process 300 can further include tracking items purchased by the customer and generating a current customer profile that incorporates data relating to the identified items, as shown in process portion 306. Customer purchases can be tracked through the use of a customer identifier as described above. For example, a customer can provide a customer affinity card or enter a telephone number, name, or other customer information in the customer identifier at checkout. The card can be scanned or the associated number entered into a computer at the checkout register. The items that are purchased can then be identified and associated with the customer identifier. The items purchased by the consumer can be analyzed to determine food products that are most commonly bought and/or to determine other consumer characteristics. For instance, a customer who buys whole wheat flour, yeast, and baking powder may be more likely to use or enjoy more complex recipes involving substantial preparation than another consumer who tends to purchase pre-made or pre-cooked food items (e.g., microwave dinners, canned spaghetti, and meal replacement bars). Additionally, the types of food items purchased can provide an indication of the kinds of equipment to which the consumer has access. For example, if the consumer buys whole coffee beans, the consumer likely has access to a coffee grinder.

Customer purchases can also be tracked in other ways. In one embodiment, customer-specific discounts or promotions can be used to track at least one of the items purchased by a customer. For example, paper or electronic coupon(s) for specified items can be printed with a recipe or shopping list provided to a customer. The coupon(s) can contain information, e.g., in a bar code, that includes or correlates to a customer identifier. Whether the customer purchases an item and redeems the coupon can then be tracked accordingly. Customer surveys and interviews can also be used to obtain a purchase history. Data relating to the tracked purchases can then be incorporated in an updated, current customer profile.

The process 300 can further include accepting rating surveys from the customer regarding recipes that have been provided to the customer previously, as shown in process portion 308. For example, a web site can be provided where the customer can login with a customer identifier and be asked to fill out an electronic survey with questions regarding the provided recipes. For example, questions can include whether the recipes were easy to follow, whether the food prepared was satisfactory, whether there was any missing ingredient, and whether the customer would like to have the same recipes again. The collected survey information can be used to update the customer profile. For example, if the customer does not like a particular recipe, that recipe can be marked to be excluded from recommendation in the future. Other embodiments of accepting rating surveys can include, for example, having the customer fill out a paper survey form and mail in the form for data entry, taking a survey by a store representative when the customer returns, or conducting a telephone interview after the customer has had time to use the provided recipes.

Once generated, the initial customer profile can be used as the current customer profile (e.g., when zero customer purchased items are identified) until a customer purchase history or rating survey history can be established. In certain embodiments, the current customer profile can be updated continuously or periodically to reflect the purchase history of a customer and/or by adding additional customer information, as illustrated by process portion 310. In some embodiments, the initial customer profile can incorporate data relating to the customer's previously recorded purchase history; a customer affinity card can assist in identifying that history.

If there are no new customer purchases or rating surveys, then the current customer profile is provided for further processing, as illustrated by process portion 312. For example, the current customer profile can be loaded into a processor 101 and compared with a promotional strategy to develop recommended recipes, as further described below with reference to FIG. 4.

D. Promotional Strategies and Secondary Correlations

FIG. 4 illustrates a process 400 for generating a comparison between at least a customer profile and a promotional strategy. Promotional strategies and/or correlations between the sales of various food items can be combined with customer profile to generate recipes that are consistent with customer profile, promotional strategies, and other relationships.

As discussed above with reference to FIG. 3, the customer profile can include initial profiling by a store representative, customer-supplied information, and/or other information (e.g., demographics and/or customer purchase history). A customer identifier can be used to identify the customer profile and to identify the customer for whom the recipe request is being made (e.g., by the customer or a store representative). As shown in process portion 402, the customer has the option to override and substitute the current customer profile with a new customer profile.

If the customer decides not to override the existing profile, the existing customer profile can be compared to a defined promotional strategy (process portion 404). If the customer decides to override the existing profile, a new customer profile can be compared to a defined promotional strategy (process portion 406). The comparison performed at process portion 404 and 406 can include querying recipes that meet criteria developed from both the customer profile and the promotional strategy. The process of defining a promotional strategy is further described below with reference to FIG. 6.

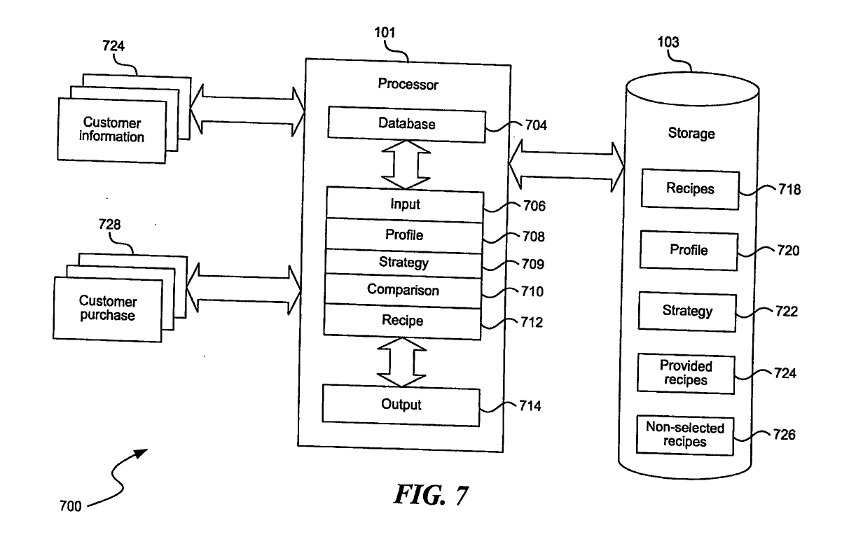

In one embodiment, recipes 718 contained in the database 103, as shown in FIG. 7, can have at least a binary identifier and an analog identifier. For example, a binary identifier can be an identifier indicating low fat or regular, low carbohydrate or regular, high protein or low protein, for novice cook or for professional cook, and etc. An exemplary analog identifier can be amount of preparation time, degrees of complexity, types of cuisine, and etc. Preferably, an analog identifier can allow at least three values.

In one embodiment, during the comparison process portion 404 or 406, the recipe records 718 can be queried first by at least one binary identifier. For example, if the customer prefers low fat recipes, all recipes not with a low fat identifier would be excluded. Then, the resulting records can be queried according to at least one analog identifier, for example, degrees of complexity. The results can be returned sorted according to the degrees of complexity of the recipes. In another embodiment, the recipe records 718 can be queried first by at least one analog identifier, and then by at least one binary identifier.

Optionally, process 400 can include identifying correlations between products wherein the correlations are based on the probability that if a customer buys a first item, the customer will also by a second item (process portion 408), and comparing the customer profile, the correlations, and the promotional strategy (process portion 410). In one implementation, these relationships can be formed by tracking consumer purchases and recording how many times certain item combinations are purchased versus how many time the items are purchased individually (e.g., tracking data can show that ranch dressings are more frequent in purchases that include carrots than in purchases without carrots). The customer profile can be compared to a defined promotional strategy (as discussed above) and the relationship between food items.

In another embodiment, process 400 can include querying recipe records, as illustrated by process portion 412. In one embodiment, each time when system 100 provides recipes in response to the customer's request, all generated recipes can be stored as a provide recipe record 724 in the database 103, as shown in FIG. 7. Querying the provided recipe records 724 can determine if a particular recipe resulted from the process portions of 404, 406 or 410 have already been provided to the customer previously. As a result, a decision can be made to either offer the same recipe because the customer seems to enjoy the recipe, or preclude the recipe being offered again for a pre-determined period of time. In another embodiment, each time the customer does not select a generated recipe, the recipe and the non-selection occurrence is stored as a non-selection recipe record 726 in the database 103, as shown in FIG. 7. Querying the non-selection recipe records can determine how many times a recipe has been offered but declined. As a result, a decision can be made to not offer the particular recipe again for a predetermine amount of time or forever.

In another embodiment, process 400 can also include filtering recipes by other factors, as illustrated in process portion 414. Other factors include, for example, season, holidays, weather, day of week, shopping time of day, and at least one operating schedule of at least one department in a store. The filtering can include, for example, excluding recipes based on the above discussed exemplary factors. As an example, recipes that require items from a deli can be excluded if the shopping time of day is beyond normal operating hours of the deli. The filtering can also accord different priorities to the recipes such that the recipes can be shown to the customer with a defined preference. For example, recipes that require a long preparation time can be accorded a lower priority than recipes that require a short preparation time if the shopping time is close to dinner time.

D. Providing Recipes to Customer

FIG. 5 illustrates a process 500 for providing recipes to the customer. As shown in process portion 502, a recipe or multiple recipes generated based on a comparison of the customer profile and a promotional strategy can be shown to the customer. In certain embodiments, the recipe(s) can be printed out for convenient use. In other embodiments, the recipe(s) can be simply displayed for customer viewing (e.g., on a kiosk), or downloaded into a mobile computing device (e.g., a PDA) and carried through the store.

As shown in process portion 504, if multiple recipes are provided to the customer, then the customer can select one or more recipes from the provided options. The selection operation can be performed via, for example, marking a print out of the multiple recipes, inputting selection on a display (e.g., on a kiosk), or communicating with a store representative. The selection operation can further include a confirmation operation where the customer is required to confirm the selection and is allowed an opportunity to change his or her mind.

In further embodiments, the process can include providing a shopping list of food items (process portion 510) that are needed to complete the recipe and/or are associated with the recipe. Although the recipe itself contains the various food items needed to complete the recipe, a shopping list of food items in a simplified, organized, and/or more convenient format can be provided. For example, the shopping list can be divided into a first group of products (pantry items) that the consumer likely already has (e.g., salt and pepper) and a second group (the need-to-buy items) that the consumer likely will need to buy (e.g., a salmon fillet). The division into pantry items and need-to-buy items can be based on the customer profile. For example, if the customer profile indicates that the customer is an avid cook, then pantry items typically include more sophisticated products (e.g., balsamic vinegar).

Additionally, the food list can include other items associated with the recipe, such as other foods the customer might like if the customer has selected the recipe and/or suggestions for foods that could accompany the recipe (e.g., a selected bottle of wine). In other embodiments, the food list can also include items that are not associated with the recipe. For example, the list can contain a reminder to buy certain staple foods, e.g., flour, and/or promote food items that are on sale. In other embodiments, the food list can be integrated with other items not necessarily related to food that the customer intends to buy (process portion 520). For example, the customer can enter other items, for instance, paper towels, kitchen utensils, light bulbs, or any other items the customer desires, via a display (e.g., on a kiosk), a web site, or a store representative. The entered items are integrated into the list containing food items such that the customer has a complete list of items to purchase for the trip.

In other embodiments, the process can generate a store map with the location of food items that are associated with the recipe (process portion 516). The map can aid in the efficient collection of the food items to avoid the frustration associated with searching for specific items. In one embodiment, the generated map can contain locations of the various items defined by categories. For example, black pepper can be categories as condiments and be assigned a general location. The advantage of the categorization is to avoid the time consuming process of updating location data of each and every item carried by a store. In still other embodiments, the process can generate a shopping sequence for collecting the food items associated with the recipe based on the location of the food items in the store (process portion 512). This too can aid in the efficient collection of food items. In other embodiments, the process 500 can then generate a map and/or a shopping sequence for all the food items as well as other items entered by the customer on the combined/edited list.

In certain embodiments, the shopping list, map, and/or the shopping sequence can be printed out for convenient use. In other embodiments, the shopping list, map, and/or the shopping sequence can be simply displayed for customer viewing (e.g., on a kiosk). In still other embodiments, the list of food items, map, and/or the shopping sequence can be downloaded into a mobile computing device (e.g., downloaded into a PDA) and carried through the store.

In other embodiments of the invention, the process can include providing a discount incentive for the customer to purchase at least one food item associated with the recipe (process portion 514). For example, the customer can be provided a paper coupon for one or more selected items associated with the recipe. The paper coupon can be redeemed at checkout for a discount on the purchase of the selected item. The paper coupon can be pre-printed or printed in response to a recipe request or selection (e.g., by a printer or printing device accessed by a store representative or by a self-serve kiosk). In other embodiments, discount incentives can be provided for each item required for the recipe. In still other embodiments, discount incentives can be provided for each item required for the recipe that the consumer is unlikely to already have.

In another embodiment, an electronic coupon can be provided. For example, the electronic coupon for a selected food item can be generated with a customer identifier in response to a recipe request or selection, and stored in a computing device (e.g., a store computer networked with the checkout register or self-serve checkout station). When the customer begins the checkout process, the customer can provide a customer identifier and the electronic coupon (e.g., discount) can be applied to the purchase of the item. As mentioned above, customer-specific discount incentives (e.g., paper or electronic) can be used to track the items purchased by a selected customer and this information can be used to update the current customer profile.

Yet another feature of various embodiments described above is that the store can build relationships with the customer, for example, by providing these services through a store representative and/or a kiosk. An advantage of this feature is that goodwill can be established between the customer and the store based on the value, time savings, and convenience that the process can provide.

E. Defining Promotional Strategy

FIG. 6 illustrates a process 600 for defining a promotional strategy. As shown in process portion 602, a promotional strategy can be first defined by, for example, a retail store or a supplier. Promotional strategies can include tactics to sell more of a certain product, to increase ancillary sales, and/or to increase the percentage of a customer's food budget that is spent at a specific store. In certain embodiments, individual strategies of several different entities can be combined and weighted to form a single promotional strategy. For example, a supplier and a retail store may desire to promote various products and/or to increase the percentage of the customer's food budget that is spent in the store. These two promotional strategies can be combined into a single strategy to aid in achieving the goals and objectives of both the retail store and the supplier.

By way of example, a meat supplier may desire to increase sales of a selected cut of meat, e.g., a cut of meat that is on sale or a cut of meat with which many customers are unfamiliar, but may provide good value even when not on sale. In response to a recipe request from a customer who likes beef, a recipe for a selected cut of beef may be given priority over other recipes. Additionally, a recipe that can highlight the selected cut's best features may be given priority over other recipes that use the selected cut of beef (e.g., a recipe that makes the cut more tender might be given priority over a recipe where the meat will be tougher or that calls for a different cut). This can increase beef sales, which can be beneficial to both the retail store and the meat supplier. At the same time, the retail store can desire to increase the sale of a selected piece of produce, for example, produce with higher margins and/or shorter shelf life. Giving recipes that include the selected cut of meat and the particular produce priority over other recipes can increase the sale of both the selected cut of meat and the produce.

Another promotional strategy or component thereof can be to increase ancillary sales. Possible benefits from ancillary sales include promoting products with higher profit margins on the ancillary product than the product(s) in the recipe. Other benefits of such ancillary sales is that the customer might not have bought the additional item from the specific store and/or the customer may spend more time in the store collecting the recommended product(s) and realize that he or she also needs to buy an additional product. For example, customers buying cuts of beef may be more likely to buy wine when they purchase steaks or roasts than when they purchase hamburger. Accordingly, in some cases, it can be more beneficial to the store if the customer buys steaks and wine than if the customer buys hamburger even if the customer buys a smaller portion of beef overall. Therefore, for customers that eat beef, a recipe that includes steak may be given a higher priority than a recipe that includes hamburger.

Yet another promotional strategy can include increasing the percentage of a customer's food budget that is spent in a selected store. Many customers shop for food items at a variety of stores and/or choose to eat at restaurants to save time and/or avoid the hassle of shopping for groceries. These consumers spend a portion of their food budget at each of these stores and restaurants. If a store can get each customer to increase the percentage of his or her food budget that he or she spends in the store by a relatively small amount, the overall increase in store revenue can be significant.

These promotional goals can be accomplished in a variety of ways. For example, as discussed above, providing recipes correlated to increased sales of ancillary products is expected to increase the percentage of a customer's budget spent at a specific store. Also, as discussed above, by providing recipes consistent with customer information, the customers can perceive an increase in value and convenience and be motivated to spend more of their food budget at the selected store (e.g., shop less at other stores and/or eat fewer meals at restaurants). Additionally, recipes that call for numerous ingredients and/or staple food products can be given priority over recipes that require few food items. This can increase the amount of staple food items that are purchased at the store, the overall number of ingredients purchased, and/or the amount of time the consumer spends in the store. Because consumers may be less likely to visit another store for just one or two items, if the provided recipes induce consumers to buy a larger number of the products they need from the selected store, they may also buy the few additional items they need from the store instead of making a separate trip to another store.

The effectiveness of the process can be assessed by tracking various parameters, and in some cases revenue can be provided to the process provider (e.g., a company that installs, maintains, and/or operates a system that provides the process in a store) based on the use and/or effectiveness of the process (process portion 604). For example, if a kiosk is used by a customer during a portion of the process, the time spent at the kiosk can be tracked. Additionally, the number of times a selected customer uses the process via a kiosk or a store representative can be tracked (e.g., by a customer identifier). The time between the use of the process and checkout can also be tracked. In other embodiments, the items a specific customer purchases can be tracked to identify items associated with a recipe provided by the process. The customer's purchases can also be tracked to identify ancillary items, the purchase of which likely was prompted or suggested by the recipe.

Just as the consumer profile can be updated continuously or periodically, the promotional strategies can also be updated to be more effective as business objectives and goals change (process portion 606). For example, the items purchased by consumers can be tracked to determine ancillary relationships, to assess the effectiveness of the current promotional strategies, and/or to improve the service provided to the consumer. In some cases, promotional strategies can be adjusted daily.

Another feature of several of the embodiments described above is that recipes that are consistent with the operating objectives and supply conditions of a retail store can be recommended to customers. This can increase the sales of overstocked and/or perishable items to better align the supply conditions with customer demands.

F. Computing System Software Modules

FIG. 7 illustrates a functional diagram showing exemplary software modules 700 suitable for use in computing system 100. Each component is a computer program, procedure or process written as source code in a conventional programming language, such as the C++ programming language, and is presented for execution by the CPU of processor 101. The various implementations of the source code and object and byte codes can be stored on a computer-readable storage medium or embodied on a transmission medium in a carrier wave. The modules of processor 101 include database module 704, input module 706, profile module 708, strategy module 709, comparison module 710, recipe module 712, and optionally an output module 714. In another embodiment, the software modules 700 can be presented for execution by the CPU of a network server in a distributed computing scheme.

The database 704 organize records including the recipes 718, individual customer profiles 720, promotional strategies 722, provided recipes 724, and non-selected recipes 726. Any type of database organization could be utilized, including a flat file system, hierarchical database, relational database, or distributed database, such as provided by database vendor, such as Oracle Corporation, Redwood Shores, Calif.

The input module 706 accepts customer input such as customer information or recipe selection and communicate the accepted information or selection to other components for further processing. The profile module 708 receives collected customer information 724, optionally tracks items purchased 728 by the customer, accepts customer ratings, and generates a customer profile 720 stored in the database 103 as described above with reference to FIG. 3. The strategy module 709 optionally monitors and updates a promotional strategy for generating increased sales in a store as described above with reference to FIG. 6. The comparison module 710 compares a customer profile with a promotional strategy to generate recipes that are based on both the customer's preferences as well as the promotional strategy of a retail store as described above with reference to FIG. 4.

The recipe module 712 provides the generated recipes based on the comparison of the customer profile with a promotional strategy to the customer. In other embodiments, if multiple recipes are generated, the recipe module 712 can also accept selection of at least one recipe by the customer, and then provide at least one selected recipe to the customer. In other embodiments, the recipe module 712 can also generate and provide a list of food items, a shopping sequence, provide discount incentives, and a store map for the customer as described above with reference to FIG. 5.

Optionally, the processor 101 includes an output module 714 for displaying, printing, or downloading the generated recipes, shopping list, map, and/or shopping sequence for the customer. A suitable output module 714 can be a printer driver that enables the processor 101 to print out the generated recipes, shopping list, map, and/or shopping sequence on the printer 105.

The above-detailed embodiments of the invention are not intended to be exhaustive or to limit the invention to the precise form disclosed above. Specific embodiments of, and examples for, the invention are described above for illustrative purposes, but those skilled in the relevant art will recognize that various equivalent modifications are possible within the scope of the invention. For example, even though steps are presented in a given order, alternative embodiments may perform the same steps in a different order. The various embodiments described herein can be combined to provide further embodiments.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Use of the word “or” in reference to a list of items is intended to cover a) any of the items in the list, b) all of the items in the list, and c) any combination of the items in the list.

In general, the terms used in the following claims should not be construed to limit the invention to the specific embodiments disclosed in the specification unless the above-detailed description explicitly defines such terms. In addition, the inventors contemplate various aspects of the invention in any number of claim forms.

I/We claim:

1. A method for generating a recipe, comprising:
comparing a customer profile of a customer to a defined promotional strategy; and
providing a recipe to the customer based on the comparison of the customer profile and the defined promotional strategy.

2. The method of claim 1, further comprising:
collecting customer information from the customer;
generating a customer profile based on the collected customer information and storing the generated customer profile in a database.

3. The method of claim 1 wherein providing the recipe includes providing at least one recipe that includes food items for at least one of a single dish and an entire meal.

4. The method of claim 1, further comprising providing the customer with a list of food items associated with the recipe.

5. The method of claim 4, wherein the list of food items comprises a list of pantry items and a list of need-to-buy items based on the customer profile.

6. The method of claim 4, further comprising:
accepting a list of additional shopping items from the customer; and
integrating the accepted list of additional shopping items with the list of need to buy items.

7. The method of claim 1, further comprising:
providing the customer with a list of food items associated with the recipe; and
providing the customer with a list of suggested food items not associated with the recipe.

8. The method of claim 1 wherein providing the recipe includes providing multiple recipes, and wherein the method further comprises:
receiving a selection of one or more of the multiple recipes; and
providing a list of food items associated with the one or more selected recipes.

9. The method of claim 8, further comprising storing at least one non-selected recipe and each non-selection occurrence as non-selected recipe records in a database, querying the non-selected recipe records in the database to determine how many times the non-selected recipe has been declined, and precluding the non-selected recipe from being offered again if the non-selection occurrence exceeds a predetermine number.

10. The method of claim 1, further comprising downloading at least one of the recipe and a list of food items associated with the recipe to at least one of a computing system and a computer-readable medium.

11. The method of claim 1, further comprising accepting customer rating of the provided recipe at a later date and updating the customer profile with the accepted customer rating.

12. The method of claim 11, wherein the accepting customer rating comprises accepting customer rating via a web site, an in-store computing station, or a store attendant.

13. The method of claim 1, further comprising generating a store map with the location of the food items associated with the recipe, wherein the location of the food items are defined by categories.

14. The method of claim 13, further comprising:
printing the map for the customer to use while shopping.

15. The method of claim 1, further comprising generating a shopping sequence for collecting the food items for the recipe based on the location of the food items in a store.

16. The method of claim 1 wherein the promotional strategy includes suggesting recipes that includes one or more food items that are at least one of currently in stock, over-stocked, on sale, and targeted for increased sales.

17. The method of claim 1 wherein the promotional strategy includes suggesting recipes that includes one or more food items that include a food staple.

18. The method of claim 1 wherein the promotional strategy includes according recipes with more ingredients higher priority than recipes with fewer ingredients.

19. The method of claim 1 wherein the promotional strategy includes according recipes that increase ancillary sales higher priority than recipes that do not increase ancillary sales.

20. The method of claim 1, further comprising providing a discount incentive for the customer to purchase at least one food item associated with the recipe, wherein the discount incentive is selected from the group consisting of a printed coupon, a gift card, and an electronic coupon.

21. The method of claim 1 wherein the customer profile is compared to the defined promotional strategy using a computing device.

22. The method of claim 1 wherein collecting customer information includes at least one of initial profiling by a store attendant, collecting information provided by a customer, and tracking items the customer buys.

23. The method of claim 22 wherein tracking the items the customer buys includes tracking what the customer buys over a period of time via at least one of the use of a customer affinity card and the redemption of one or more customer-specific discount incentives, and further comprises updating the customer profile with the tracked items either continuously or periodically.

24. The method of claim 1, further comprising storing the provided recipe as one of a provided recipe records in a database, querying the provided recipe records when providing a new recipe, and precluding the previously provided recipe as a new recipe for a predetermined period of time.

25. The method of claim 1, wherein providing a recipe to the customer further comprises taking into consideration factors selected from the group consisting of season, holidays, weather, day of week, shopping time of day, and at least one operating schedule of at least one department in a store.

26. The method of claim 1, further comprising overriding the customer profile, and wherein comparing the customer profile to a defined promotional strategy comprises comparing a new customer profile to a defined promotional strategy.

27. The method of claim 1, wherein comparing the customer profile to a defined promotional strategy further comprises querying a recipe database having recipes with at least one binary identifier and one analog identifier, wherein the querying a recipe database comprises querying either according to at least one binary identifier prior to at least one analog identifier or according to at least one analog identifier prior to at least one digital identifier.

28. The method of claim 1, further comprising identifying correlations between items based on the probability that if a customer buys a first item, the customer will also buy a second item, and wherein comparing the customer profile to a defined promotional strategy comprises comparing the customer profile, a defined promotional strategy, and the identified correlations.

29. The method of claim 1, further comprising defining a promotional strategy for increased sales.

30. The method of claim 29, further comprising:
(i) monitoring store sales while the promotional strategy is on going;
(ii) comparing monitored store sales with the defined promotional strategy; and
(iii) modifying the promotional strategy based on the comparison of monitored store sales with the current promotional strategy for increasing store sales.

31. The method of claim 30, further comprising repeating operations (i)-(iii) either continuously or periodically.

32. A system for generating a recipe, comprising:
a database storing customer profiles and recipes;
a processor generating at least one recipe based on the customer profiles and a defined promotional strategy, comprising:
a database module retrieving a customer profile from the database based on the collected customer information;
a comparison module comparing a customer profile of a customer to the defined promotional strategy; and
a recipe module providing a recipe to the customer based on the comparison of the customer profile and the defined promotional strategy.

33. The system of claim 32, further comprising:
an input module collecting customer information from the customer; and
a profile module generating a customer profile based on the collected customer information, and wherein the database module stores the generated customer profile in the database.

34. The system of claim 32, wherein the recipe module provides at least one recipe that includes food items for at least one of a single dish and an entire meal.

35. The system of claim 32, wherein the recipe module provides the customer with a list of food items associated with the recipe.

36. The system of claim 32, wherein the input module accepting a list of additional shopping items from the customer and the recipe module integrating the accepted list of additional shopping items with the list of need to buy items.

37. The system of claim 32, further comprising:
the recipe module providing the customer with a list of food items associated with the recipe and with a list of suggested food items not associated with the recipe.

38. The system of claim 32, wherein the recipe module provides multiple recipes, and wherein the method further comprises:
the input module receiving a selection of one or more of the multiple recipes; and
the recipe module providing a list of food items associated with the one or more selected recipes.

39. The system of claim 32, further comprising an output module downloading at least one of the recipes and a list of food items associated with the recipe to at least one of a computing system and a computer-readable medium.

40. The system of claim 32, further comprising a strategy module defining a promotional strategy for increased sales.

41. The system of claim 40, wherein the strategy module:
(i) monitors store sales while the promotional strategy is on going;
(ii) compares monitored store sales with the defined promotional strategy; and
(iii) modifies the promotional strategy based on the comparison of monitored store sales with the current promotional strategy for increasing store sales.

42. The system of claim 41, wherein the strategy module repeats operations (i)-(iii) either continuously or periodically.

43. A computer-readable medium having computer executable instructions for performing steps to generate a recipe, the steps comprising:
retrieving a customer profile of a customer from a database based on collected customer information;
comparing the customer profile to the defined promotional strategy; and
providing a recipe to the customer based on the comparison of the customer profile and the defined promotional strategy.

44. The computer-readable medium of claim 46, the computer executable instructions further comprising the steps of collecting customer information from the customer, generating a customer profile based on the collected customer information, and storing the generated customer profile in the database.

45. The computer-readable medium of claim 46, wherein the step of providing a recipe comprises providing at least one recipe that includes food items for at least one of a single dish and an entire meal.

46. The computer-readable medium of claim 46, the computer executable instructions further comprising the step of providing the customer with a list of food items associated with the recipe.

47. The computer-readable medium of claim 46, the computer executable instructions further comprising the steps of accepting a list of additional shopping items from the customer and the recipe module integrating the accepted list of additional shopping items with the list of need to buy items.

48. The computer-readable medium of claim 46, the computer executable instructions further comprising:
the step of providing the customer with a list of food items associated with the recipe and with a list of suggested food items not associated with the recipe.

49. The computer-readable medium of claim 46, the computer executable instructions further comprising, wherein the step of providing a recipe provides multiple recipes, and wherein the computer executable instructions further comprises:
the step of receiving a selection of one or more of the multiple recipes; and
the step of providing a list of food items associated with the one or more selected recipes.

50. The computer-readable medium of claim 46, the computer executable instructions further comprising the step of downloading at least one of the recipes and a list of food items associated with the recipe to at least one of a computing system and a computer-readable medium.

51. The computer-readable medium of claim 46, the computer executable instructions further comprising steps for defining a promotional strategy for increased sales.

52. The computer-readable medium of claim 51, the computer executable instructions further comprising steps for:
(i) monitoring store sales while the promotional strategy is on going;
(ii) comparing monitored store sales with the defined promotional strategy; and
(iii) modifying the promotional strategy based on the comparison of monitored store sales with the current promotional strategy for increasing store sales.

53. The computer-readable medium of claim 52, the computer executable instructions further comprising steps for repeating operations (i)-(iii) either continuously or periodically.
